(19) United States
(12) Patent Application Publication
(10) Pub. No.: US 2002/0172048 A1
(43) Pub. Date: Nov. 21, 2002

(54) Lamp locking mechanism

(76) Inventors: Eduardo Ghelman, Etobicoke (CA); Jerzy Gawalkiewicz, Mississauga (CA)

Correspondence Address: Shawn D. Jacka, Bereskin & Parr, 40 King Street West, Box 401, Toronto, ON, M5H 3Y2, CA

(21) Appl. No.: 09/860,617

(22) Filed: May 21, 2001

(51) Int. Cl. F21V 11/00

(52) U.S. Cl. 362/368

(57) ABSTRACT

A light source locking mechanism comprising a housing configured to receive a light source, wherein the housing has a central axis. The locking mechanism also includes an engaging mechanism coupled to the lamp housing and radially disposed about the central axis. The engaging mechanism comprises a plurality of rollers to releasably engage the light source as well as a biasing apparatus coupled to the rollers to flexibly bias the rollers towards the central axis.

### FIELD OF THE INVENTION

The present invention relates generally to the field of light emitting apparata, with common but by no means exclusive application to photocuring devices.

### BACKGROUND OF THE INVENTION

Certain light emitting devices such as photocuring devices require relatively precise alignment of the light source within the housing of the device to ensure efficient emission of light. These same light sources often require replacement.

Prior art techniques for properly aligning light sources are time consuming and frequently require special tools for adjustment.

Accordingly, the inventors have recognized a need for a locking mechanism, which provides a relatively simple means for aligning the light source.

### SUMMARY OF THE INVENTION

This invention is directed toward a light source locking mechanism.

Specifically, the subject invention is directed towards a light source locking mechanism comprising a housing configured to receive a light source and an engaging mechanism coupled to the lamp housing and configured to releasably engage the light source.

The invention is further directed towards a light source locking mechanism comprising a housing configured to receive a light source, wherein the housing has a central axis. The locking mechanism also comprises an engaging mechanism coupled to the lamp housing and radially disposed about the central axis. The engaging mechanism comprises a plurality of rollers to releasably engage the light source as well as a biasing apparatus coupled to the rollers to flexibly bias the rollers towards the central axis.

### BRIEF DESCRIPTION OF THE DRAWINGS

The present invention will now be described, by way of example only, with reference to the following drawings, in which like reference numerals refer to like parts and in which:

FIG. 1 is a cross-sectional view of a locking mechanism made in accordance with the present invention, with a lamp locked within the locking mechanism.

FIG. 2 is a cross-sectional view of the housing of the locking mechanism of FIG. 1 without a lamp and without the engaging mechanism, rotated approximately 45° about the central axis in comparison to the view in FIG. 1.

FIG. 3 is a top view of the engaging mechanism for the locking mechanism of FIG. 1.

FIG. 4A is a side schematic diagram of a lamp being inserted into the locking mechanism of FIG. 1.

FIG. 4B is a graph illustrating the insertion force required over time by the insertion of the lamp illustrated in FIG. 4A.

FIG. 5A is a side schematic diagram of a lamp being removed from the locking mechanism of FIG. 1.

FIG. 5B is a graph illustrating the removal force required over time by the removal of the lamp illustrated in FIG. 5A.

FIG. 6A is a side schematic diagram of a lamp being inserted into an alternate locking mechanism made in accordance with the present invention in which the channel is substantially perpendicular to the central axis.

FIG. 6B is a graph illustrating the insertion force required over time by the insertion of the lamp illustrated in FIG. 6A.

FIG. 7A is a side schematic diagram of a lamp being removed from the locking mechanism of FIG. 6A.

FIG. 7B is a graph illustrating the removal force required over time by the removal of the lamp illustrated in FIG. 6A.

### DESCRIPTION OF THE PREFERRED EMBODIMENTS

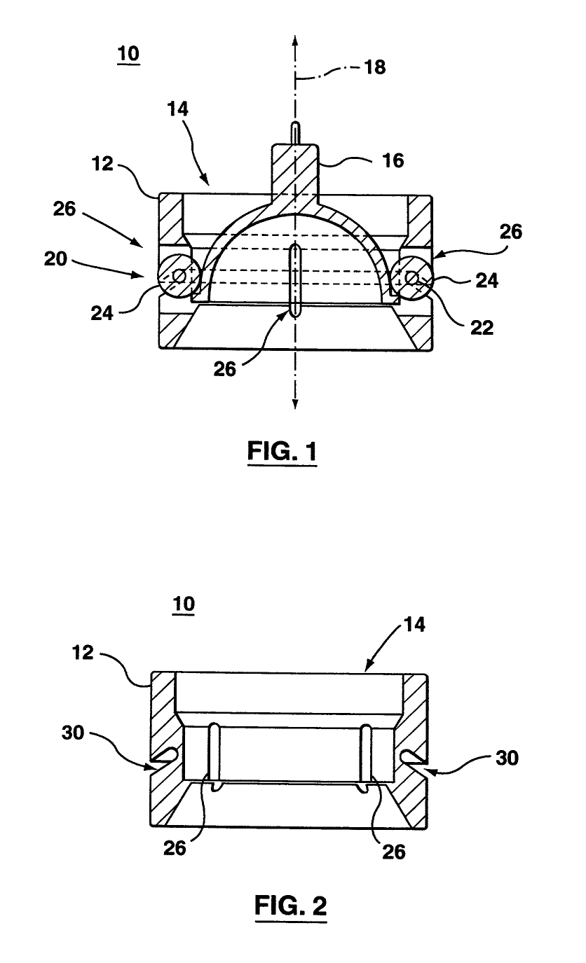

Referring simultaneously to FIGS. 1, 2 & 3, illustrated therein is a preferred embodiment of the lamp locking mechanism of the subject invention. The locking mechanism, shown generally as 10, comprises a housing 12 and a socket 14 in the housing configured to receive a light source 16, such as a lamp. The housing 12 and socket 14 are preferably substantially circular about a central axis 18.

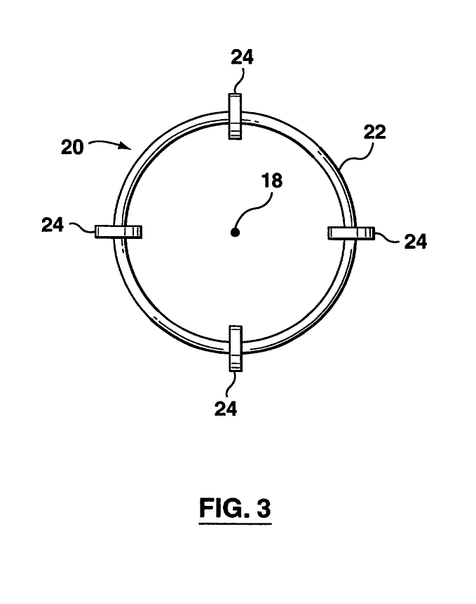

The locking mechanism 10 also includes an engaging mechanism 20. As can be seen more clearly in FIG. 3, the engaging mechanism 20 comprises a compression spring 22 radially disposed about or approximately centered about the central axis 18 (which is normal to the page on which FIG. 3 is printed) and a plurality of rollers 24 assembled onto the spring 22.

Preferably, the rollers 24 are positioned equidistant about the spring 22. As will be understood, spring 22 biases the rollers in, towards the central axis 18. The compression spring 22 is typically formed from a straight compression spring, having a hook at each end, onto which the rollers 24 are mounted. These ends are joined together, forming a circular loop. Additionally, given the spring's 22 proximity to the light source 16 and the heat generated thereby, the spring 22 will generally be made from metal or other heat resistant material.

The housing 12 preferably also comprises slots 26 sized to receive the rollers 24. As will be understood, the slots 26 are larger, vertically, than the diameter of the rollers, but are only slightly wider than the width of the rollers, in order to enable the rollers 24 to travel vertically (and radially outwardly) within the slots 26.

As can be seen more clearly in FIG. 2, the housing 12 also includes a circular channel 30 centered about the central axis. Preferably, the channel 30 is angled at an angle of less than 90° relative to the central axis 18. As noted above, preferably the rollers 24 are positioned equidistant about the spring 22. Positioning the rollers 24 in such a manner, in conjunction with the centered spring 22, helps ensure that a uniform radial force is exerted upon the light source 16 thereby correctly aligning the lamp 16.

As will be understood, the housing 12 is preferably mounted to the housing of a light emitting apparatus (not shown), for example a photocuring device, such that once the light source 16 has been inserted into the socket 14, the light source 16 is correctly aligned with any optical components or emission port which the light emitting apparatus may contain. Additionally, as will also be apparent, once the light source 16 has been inserted into the locking mechanism 10, it will still be necessary to couple the light source 16 to the power supply of the light emitting apparatus.

As well, the locking mechanism 10 has been illustrated as having four equidistant rollers 24 and corresponding slots 26. However, it should be understood that different quantities of rollers 24/slots 26 can be used, as long as the configuration adequately aligns the light source 16, once it is completely inserted into the socket 14.

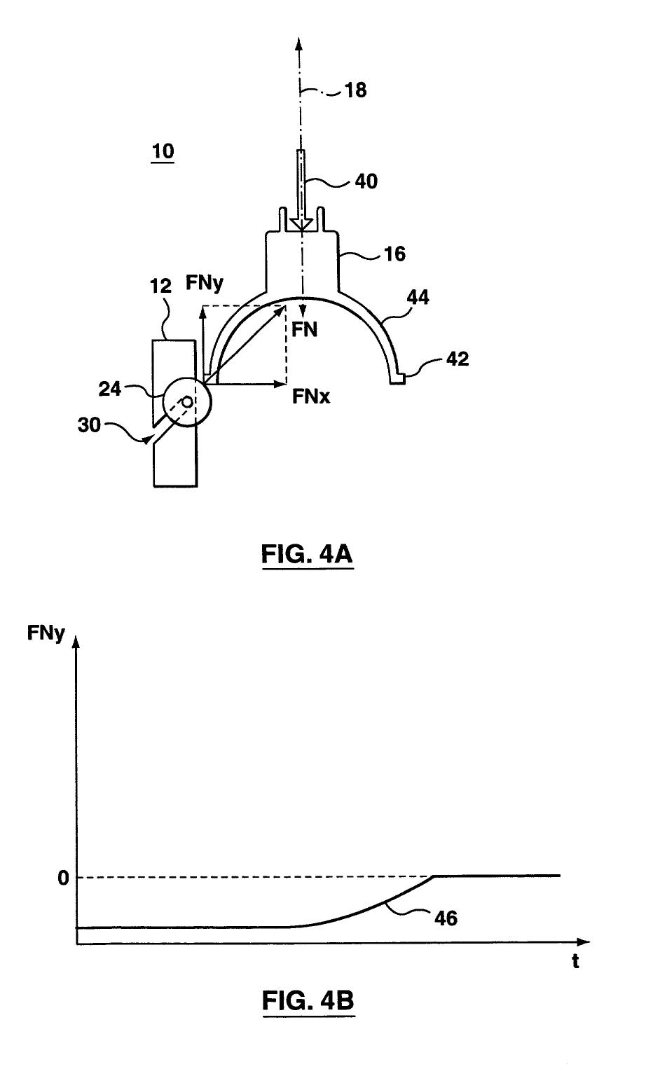

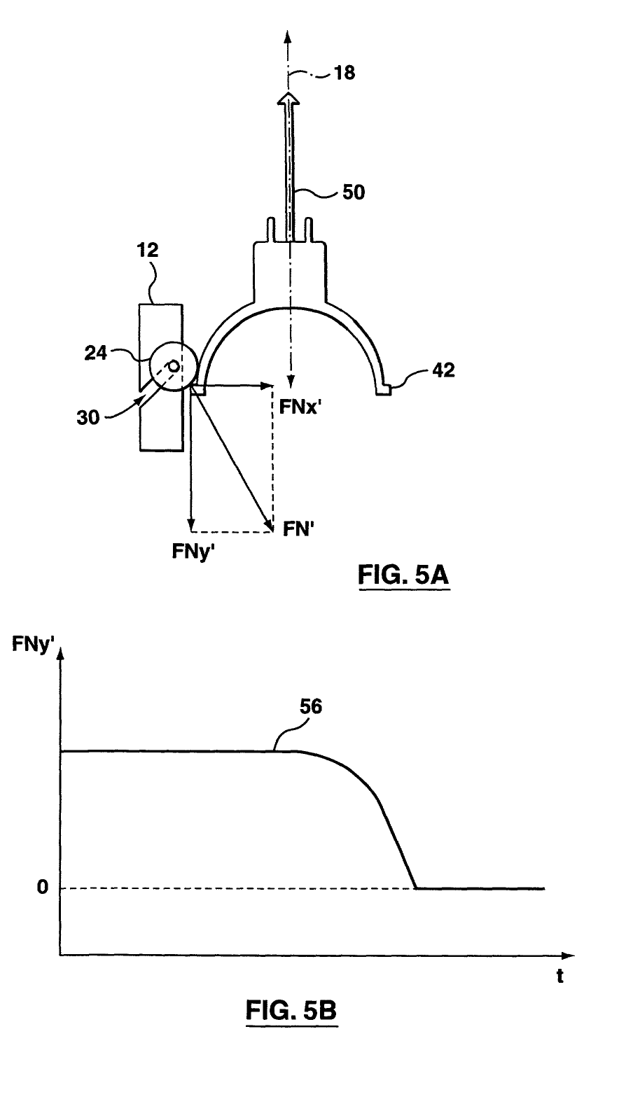

Referring now to FIGS. 4A-5B, illustrated therein is the use of the locking mechanism 10. For illustrative purposes, as will be understood, the light source 16 and the locking mechanism 10 are depicted schematically, with only one segment of the housing 12, spring 22, channel 30 and one roller 24 illustrated.

In FIG. 4A, the light source 16 is inserted into the socket 14 of the locking mechanism 10 with an insertion force illustrated by force vector 40. The force vectors FN, FNy and FNx indicate the reaction force exerted by the spring 22 (FN) as well as the vertical (FNy) and horizontal (FNx) force components.

The graph in FIG. 4B illustrates the amount of insertion force 40 required 46 over time (t) from the point at which the lip 42 of the lamp's 16 parabolic reflector 44 first engages the rollers 24. As will be understood, the insertion force 40 is opposite in direction and value to the vertical (FNy) force component of the force FN exerted by the spring 22. As the lamp 16 is inserted into the socket 14, the rollers 24 are pushed downwardly and outwardly as this interaction causes the spring 22 to follow the channel 30 downward and outward. Eventually, once the rollers 24 have substantially passed the lip 42 of the reflector 44, the insertion force 40/46 returns to 0. As should be understood, the size of the rollers 24 must be selected such that they can effectively engage and roll over the lip 42 of the reflector 44.

Referring now to FIG. 5A, the light source 16 is removed from the socket 14 of the locking mechanism 10 with a removal force illustrated by force vector 50. The force vectors FN′, FNy′ and FNx′ indicate the reaction force exerted by the spring 22 (FN′) as well as the vertical (FNy′) and horizontal (FNx′) force components.

The graph in FIG. 5B illustrates the amount of removal force 50 required 56 over time (t) from the point at which the lip 42 of the lamp's 16 parabolic reflector 44 first engages the rollers 24. As the lamp 16 is removed from the socket 14, the rollers 24 are pushed downwardly and outwardly as this interaction causes the spring 22 to follow the channel 30 downward and outward. Eventually, once the rollers 24 have substantially passed the lip 42 of the reflector 44, the removal force 50/56 return to 0.

Upon comparing the graphs of FIGS. 4B and 5B, it is apparent that the removal force 50/56 is substantially greater than and in this case approximately four times, although opposite in direction to, the insertion force 40/46. Having a removal force 50/56 that is greater than the insertion force 40/46 will generally be considered advantageous, as the light source 16 will be relatively easy to insert, but will be locked in place with a greater (removal) force.

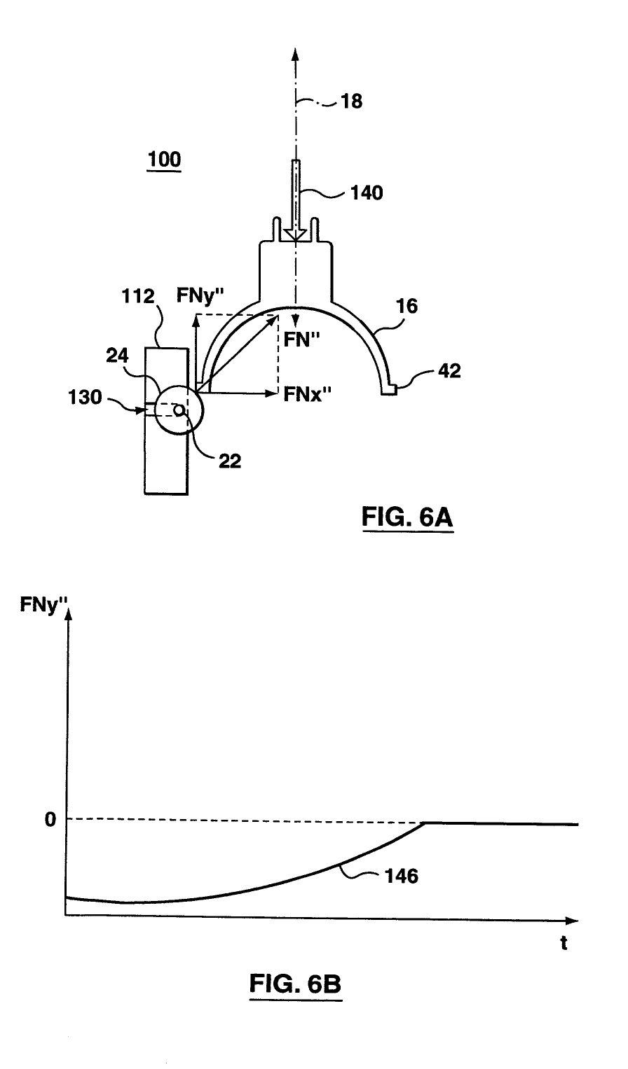

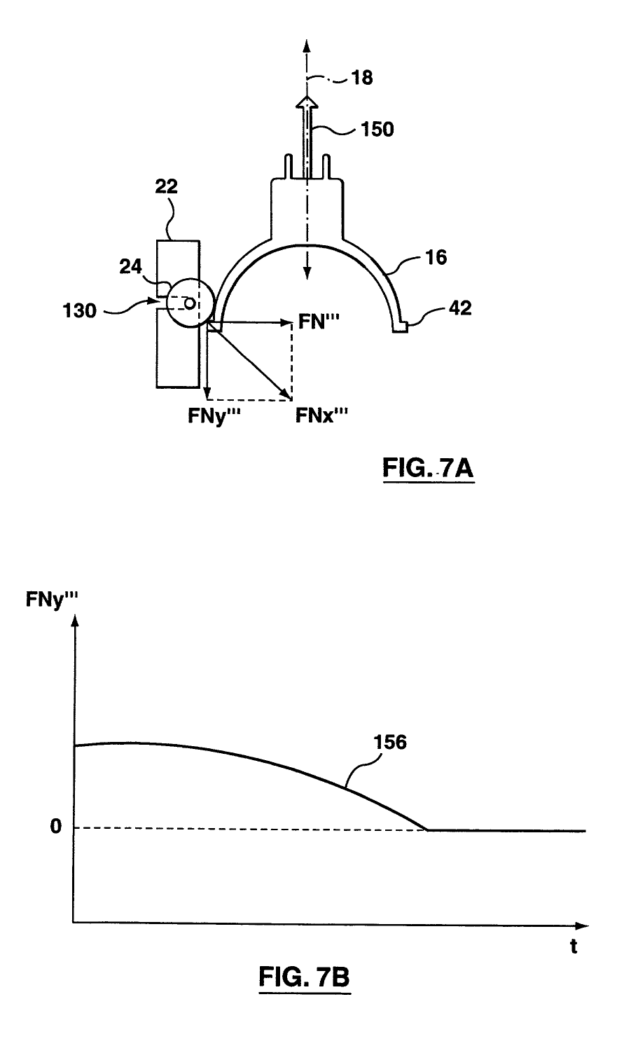

Referring now to FIGS. 6A-7B, illustrated therein is the use of an alternative embodiment of a locking mechanism, shown generally as 100. The alternative locking mechanism 100 is largely similar to the locking mechanism 10; however, instead of having a channel 30 at an angle less than 90° relative to the central axis, the channel 130 is substantially perpendicular to the central axis 18. For illustrative purposes, as will be understood, the light source 16 and the locking mechanism 100 are depicted schematically, with only one segment of the housing 112, spring 22, channel 130 and one roller 24 illustrated.

In FIG. 6A, the light source 16 is inserted into the socket 14 of the locking mechanism 100 with an insertion force illustrated by force vector 140. The force vectors FN″, FNy″ and FNx″ respectively indicate the reaction force exerted by the spring 22 (FN″) as well as the vertical (FNy″) and horizontal (FNx″) force components.

The graph in FIG. 6B illustrates the amount of insertion force 140 required 146 over time (t) from the point at which the lip 42 of the lamp's 16 parabolic reflector 44 first engages the rollers 24. As the lamp 16 is inserted into the socket 14, the rollers 24 are pushed outwardly as this interaction causes the spring 22 to follow the channel 130 outward. Gradually, as the rollers 24 pass the lip 42 of the reflector 44, the insertion force 140/146 returns to 0.

Referring now to FIG. 7A, the light source 16 is removed from the socket 14 of the locking mechanism 100 with a removal force illustrated by force vector 150. The force vectors FN′″, FNy′″ and FNx′″ respectively indicate the reaction force exerted by the spring 22 (FN′″) as well as the vertical (FNy′″) and horizontal (FNx′″) force components.

The graph in FIG. 7B illustrates the amount of removal force 150 required 156 over time (t) from the point at which the lip 42 of the lamp's 16 parabolic reflector 44 first engages the rollers 24. As the lamp 16 is removed from the socket 14, the rollers 24 are pushed outwardly as this interaction causes the spring 22 to follow the channel 130 outward. Gradually, as the rollers 24 pass the lip 42 of the reflector 44, the removal force 150/156 returns to 0. Upon comparing the graphs of FIGS. 4B and 5B, it is apparent that the removal force 150/156 is substantially equal (although opposite in direction) to the insertion force 140/146.

Thus, while what is shown and described herein constitute preferred embodiments of the subject invention, it should be understood that various changes can be made without departing from the subject invention, the scope of which is defined in the appended claims.

We claim:

1. A light source locking mechanism comprising:
(a) a housing configured to receive a light source; and
(b) an engaging mechanism coupled to the lamp housing and configured to releasably engage the light source.

2. The locking mechanism as claimed in claim 1, wherein the housing comprises a central axis, and wherein the engaging mechanism is radially disposed about the central axis.

3. The locking mechanism as claimed in claim 1, wherein the engaging mechanism comprises a plurality of engaging portions.

4. The locking mechanism as claimed in claim 2, wherein the engaging mechanism comprises a biasing apparatus.

5. The locking mechanism as claimed in claim 4, wherein the engaging mechanism comprises a plurality of rollers to engage the light source and wherein the biasing apparatus flexibly biases the rollers towards the central axis.

6. The locking mechanism as claimed in claim 5, wherein the biasing apparatus comprises a spring, and wherein the rollers are coupled to the spring.

7. The locking mechanism as claimed in claim 6, wherein the housing further comprises a channel disposed about the central axis and wherein the spring is positioned within the channel.

8. The locking mechanism as claimed in claim 7, wherein the channel is angled relative to the central axis such that the force required to remove the light source from the housing exceeds the force required to insert the light source into the housing.

9. The locking mechanism as claimed in claim 8, wherein the force required to remove the light source from the housing is at least twice as great as the force required to insert the light source into the housing.

10. The locking mechanism as claimed in claim 1, wherein the light source is a lamp, and wherein the lamp comprises a substantially parabolic reflector.

11. A light source locking mechanism comprising:
(a) a housing configured to receive a light source, wherein the housing comprises a central axis;
(b) an engaging mechanism coupled to the lamp housing and radially disposed about the central axis;
(c) and wherein the engaging mechanism comprises a plurality of rollers to releasably engage the light source; and
(d) wherein the engaging mechanism comprises a biasing apparatus coupled to the rollers to flexibly bias the rollers towards the central axis.

12. The locking mechanism as claimed in claim 11, wherein the biasing apparatus comprises a spring.

13. The locking mechanism as claimed in claim 12, wherein the housing further comprises a channel disposed about the central axis and wherein the spring is positioned within the channel.

14. The locking mechanism as claimed in claim 13, wherein the channel is angled relative to the central axis such that the force required to remove the light source from the housing exceeds the force required to insert the light source into the housing.

15. The locking mechanism as claimed in claim 13, wherein the force required to remove the light source from the housing is at least twice as great as the force required to insert the light source into the housing.

16. The locking mechanism as claimed in claim 11, wherein the light source is a lamp, and wherein the lamp comprises a substantially parabolic reflector.

17. The locking mechanism as claimed in claim 11, wherein the rollers are substantially equally radially positioned about the central axis.
